(19) United States
(12) Patent Application Publication
(10) Pub. No.: US 2026/0009943 A1
(43) Pub. Date: Jan. 8, 2026

(54) BACKLIGHT MODULE AND DISPLAY DEVICE

(71) Applicant: Coretronic Corporation, Hsin-Chu (TW)

(72) Inventors: Hsin Huang, Hsin-Chu (TW); Chung-Yang Fang, Hsin-Chu (TW); Ping-Yen Chen, Hsin-Chu (TW)

(73) Assignee: Coretronic Corporation, Hsin-Chu (TW)

(21) Appl. No.: 19/260,230

(22) Filed: Jul. 3, 2025

(30) Foreign Application Priority Data
Jul. 8, 2024 (CN) 202421598962.7

(51) Int. Cl. F21V 8/00

(52) U.S. Cl. CPC G02B 6/0053; G02B 6/0076

(57) ABSTRACT

A backlight module includes first and second light guide plates, first and second light sources, and a first prism sheet disposed on a side of a second light-emitting surface of the second light guide plate. The first and second light sources are disposed on sides of the first and second light guide plates. The second light guide plate is disposed on a side of a first light-emitting surface of the first light guide plate. First prism structures of the first prism sheet are disposed on a substrate surface of a first substrate facing the second light-emitting surface and are arranged at intervals according a spacing width and have a first structure width in a normal direction of a second light incident surface. A ratio of the spacing width to the first structure width is less than 2. A display device including the backlight module is also provided.

### CROSS-REFERENCE TO RELATED APPLICATION

This application claims the priority benefit of China application serial no. 202421598962.7, filed on Jul. 8, 2024. The entirety of the above-mentioned patent application is hereby incorporated by reference herein and made a part of this specification.

### BACKGROUND

### Technical Field

The disclosure relates to a backlight module and a display device, and in particular, relates to a backlight module and a display device provided with prism sheets respectively.

### Description of Related Art

Generally, in order to allow multiple viewers to watch together, most of the display devices feature a wide-viewing angle display effect. However, in certain situations or occasions, such as browsing private web pages, confidential information, or entering passwords in public, the screen may be easily viewed by others due to the wide-viewing angle display effect, resulting in the leakage of confidential information. In order to achieve the anti-peeping effect, the general practice is to place a light control film (LCF) in front of the display panel to filter out light at large angles.

If operational convenience is taken into consideration, another approach is to add an electrically-controlled diffusion sheet to achieve an electrically switchable anti-peeping display. Another approach is to use a combination of an additional electrically-controlled liquid crystal cell and a polarizer to electrically control the filtering of light in the anti-peeping axial direction. However, the additional electrically-controlled liquid crystal cell cannot completely eliminate the display brightness at the anti-peeping viewing angle, so that the anti-peeping effect of the display device is limited. Therefore, how to develop a display device that is convenient for switching viewing angles and provides improved anti-peeping effect has become an important issue for relevant manufacturers.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve the above one, part of, or all of the objectives or other objectives, an embodiment of the disclosure provides a backlight module. The backlight module includes a first light guide plate, a first light source, a second light guide plate, a second light source, and a first prism sheet. The first light guide plate has a first light incident surface and a first light-emitting surface connected to each other. The first light source is disposed on a side of the first light incident surface of the first light guide plate. The second light guide plate is disposed on a side of the first light-emitting surface of the first light guide plate and overlaps the first light-emitting surface. The second light guide plate has a second light incident surface and a second light-emitting surface connected to each other. The first light incident surface is not parallel to the second light incident surface. The second light source is disposed on a side of the second light incident surface of the second light guide plate. The first prism sheet is disposed on a side of the second light-emitting surface of the second light guide plate and includes a first substrate and a plurality of first prism structures. The first substrate has a substrate surface facing the second light-emitting surface. The first prism structures are disposed on the substrate surface and are arranged at intervals in a normal direction of the second light incident surface. In the normal direction of the second light incident surface, each of the first prism structures has a first structure width. A spacing width is provided between any two adjacent first prism structures. A ratio of the spacing width to the first structure width is less than 2.

In order to achieve the above one, part of, or all of the objectives or other objectives, an embodiment of the disclosure further provides a display device. The display device includes a backlight module and a display panel. The backlight module includes a first light guide plate, a first light source, a second light guide plate, a second light source, and a first prism sheet. The first light guide plate has a first light incident surface and a first light-emitting surface connected to each other. The first light source is disposed on a side of the first light incident surface of the first light guide plate. The second light guide plate is disposed on a side of the first light-emitting surface of the first light guide plate and overlaps the first light-emitting surface. The second light guide plate has a second light incident surface and a second light-emitting surface connected to each other. The first light incident surface is not parallel to the second light incident surface. The second light source is disposed on a side of the second light incident surface of the second light guide plate. The first prism sheet is disposed on a side of the second light-emitting surface of the second light guide plate and includes a first substrate and a plurality of first prism structures. The first substrate has a substrate surface facing the second light-emitting surface. The first prism structures are disposed on the substrate surface and are arranged at intervals in a normal direction of the second light incident surface. In the normal direction of the second light incident surface, each of the first prism structures has a first structure width. A spacing width is provided between any two adjacent first prism structures. A ratio of the spacing width to the first structure width is less than 2. The display panel is disposed on a side of the second light-emitting surface of the second light guide plate and overlaps the second light-emitting surface.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic side view of a display device according to a first embodiment of the disclosure.

FIG. 2 is a schematic three-dimensional view of a backlight module of FIG. 1.

FIG. 3A is a schematic cross-sectional view of a first prism sheet of FIG. 2.

FIG. 3B is a schematic cross-sectional view of another modified embodiment of the first prism sheet of FIG. 3A.

FIG. 4 is a schematic cross-sectional view of a first prism sheet of a comparative example.

FIG. 5A and FIG. 5B are light-emitting distribution diagrams of the backlight module equipped with the first prism sheet of the comparative example in FIG. 4 when operating in an anti-peeping mode and a sharing mode, respectively.

FIG. 6A and FIG. 6B are light-emitting distribution diagrams of the backlight module in FIG. 2 when operating in the anti-peeping mode and the sharing mode, respectively.

FIG. 7 is a schematic cross-sectional view of a first prism sheet according to a second embodiment of the disclosure.

FIG. 8 is a schematic cross-sectional view of a first prism sheet according to a third embodiment of the disclosure.

FIG. 9 is a schematic cross-sectional view of a first prism sheet according to a fourth embodiment of the disclosure.

FIG. 10 is a schematic cross-sectional view of a first prism sheet according to a fifth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a backlight module exhibiting a uniform light-emitting distribution in a sharing mode.

The disclosure provides a display device exhibiting improved uniformity of display brightness in the sharing mode.

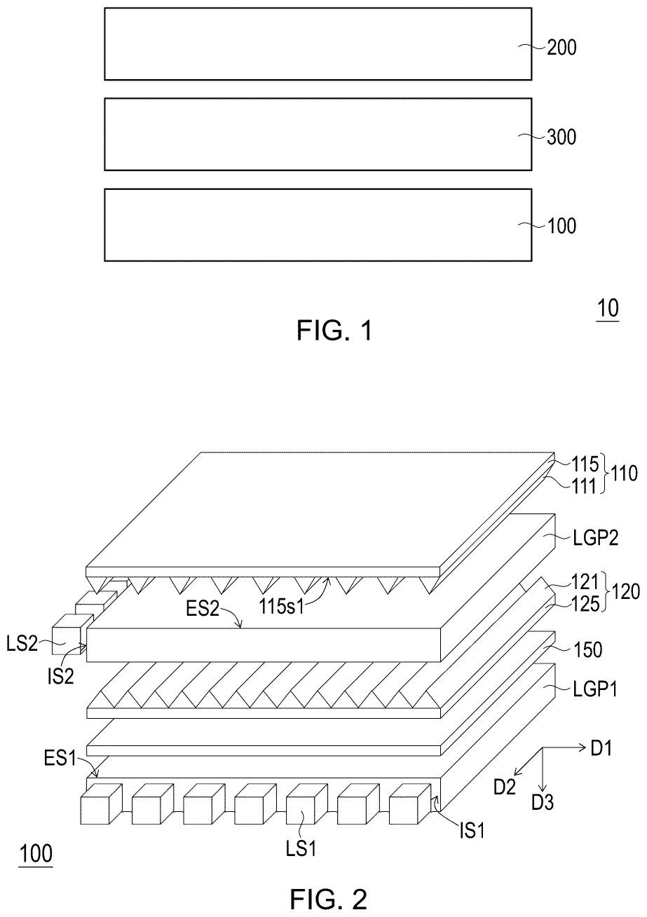

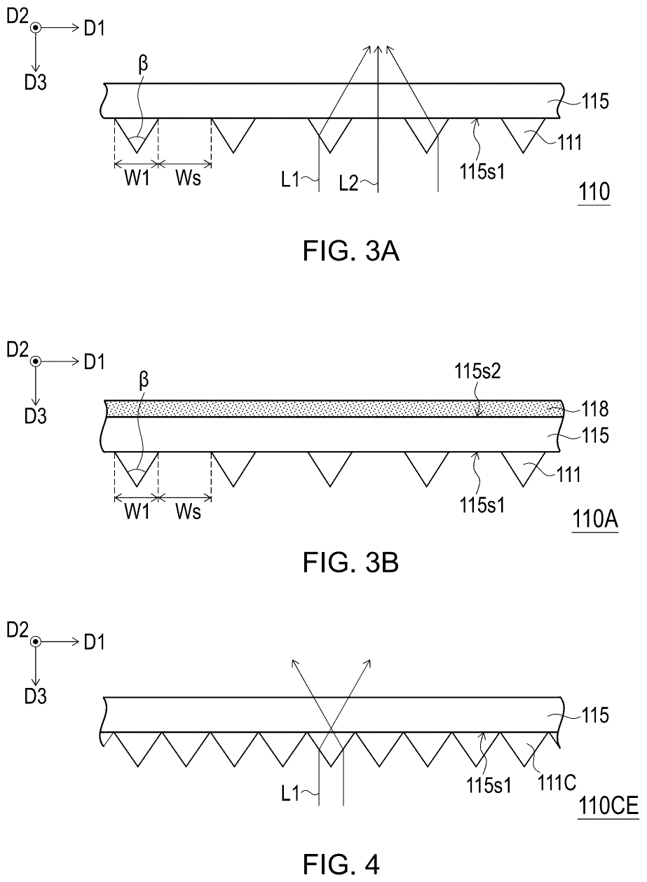

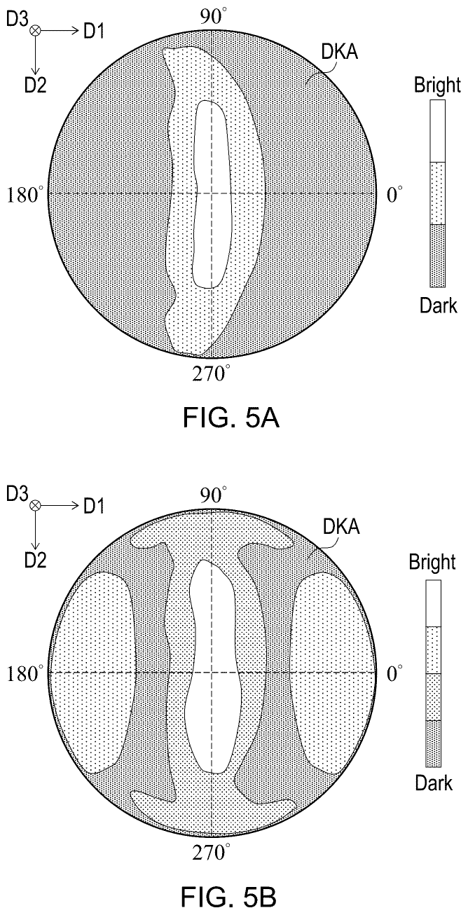

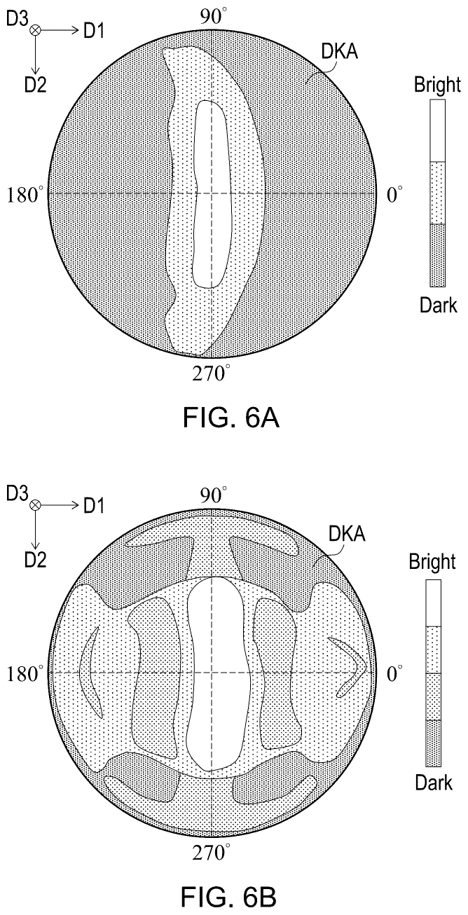

FIG. 1 is a schematic side view of a display device according to a first embodiment of the disclosure. FIG. 2 is a schematic three-dimensional view of a backlight module of FIG. 1. FIG. 3A is a schematic cross-sectional view of a first prism sheet of FIG. 2. FIG. 3B is a schematic cross-sectional view of another modified embodiment of the first prism sheet of FIG. 3A. FIG. 4 is a schematic cross-sectional view of a first prism sheet of a comparative example. FIG. 5A and FIG. 5B are light-emitting distribution diagrams of the backlight module equipped with the first prism sheet of the comparative example in FIG. 4 when operating in an anti-peeping mode and a sharing mode, respectively. FIG. 6A and FIG. 6B are light-emitting distribution diagrams of the backlight module in FIG. 2 when operating in the anti-peeping mode and the sharing mode, respectively.

With reference to FIG. 1 and FIG. 2, a display device 10 includes a backlight module 100 and a display panel 200. To be specific, the backlight module 100 includes a first light guide plate LGP1, a first light source LS1, a second light guide plate LGP2, a second light source LS2, and a first prism sheet 110. The first light guide plate LGP1 has a first light incident surface IS1 and a first light-emitting surface ES1 connected to each other. The first light source LS1 is disposed on a side of the first light incident surface IS1 of the first light guide plate LGP1. The second light guide plate LGP2 is disposed on a side of the first light-emitting surface ES1 of the first light guide plate LGP1 and overlaps the first light-emitting surface ES1 in a direction D3 (e.g., a direction parallel to a normal direction of the first light-emitting surface ES1).

The second light guide plate LGP2 has a second light incident surface IS2 and a second light-emitting surface ES2 connected to each other. The second light source LS2 is disposed on a side of the second light incident surface IS2 of the second light guide plate LGP2. The first prism sheet 110 is disposed on a side of the second light-emitting surface ES2 of the second light guide plate LGP2 and overlaps the second light-emitting surface ES2. Herein, the second light-emitting surface ES2 of the second light guide plate LGP2 faces away from the first light guide plate LGP1. That is, the second light guide plate LGP2 is disposed between the first light guide plate LGP1 and the first prism sheet 110. The display panel 200 is a non-self-luminous display panel, such as a liquid crystal display panel. The display panel 200 is disposed on a side of the second light-emitting surface ES2 of the second light guide plate LGP2 and overlaps the second light-emitting surface ES2.

It is particularly noted that the first light incident surface IS1 of the first light guide plate LGP1 is not parallel to the second light incident surface IS2 of the second light guide plate LGP2.

For instance, an included angle between the first light incident surface IS1 (a normal direction of the first light incident surface IS1) and the second light incident surface IS2 (a normal direction of the second light incident surface IS2) is greater than or equal to 75 degrees and less than or equal to 105 degrees. For example, in this embodiment, the normal direction of the first light incident surface IS1 (e.g., direction D2) may be perpendicular to the normal direction of the second light incident surface IS2 (e.g., direction D1).

It should be noted that in this embodiment, when the first light source LS1 is disabled and the second light source LS2 is enabled, the display device 10 operates in the anti-peeping mode. Herein, an anti-peeping axial direction of the display device 10 is parallel to the direction D1. When the first light source LS1 and the second light source LS2 are both enabled, the display device 10 operates in the sharing mode. That is, the display device 10 of this embodiment achieves the switching between the sharing mode and the anti-peeping mode by switching on and off different light sources.

With reference to FIG. 2 and FIG. 3A, the first prism sheet 110 includes a first substrate 115 and a plurality of first prism structures 111. The first substrate 115 has a substrate surface 115s1 facing the second light-emitting surface ES2, and the plurality of first prism structures 111 are disposed on the substrate surface 115s1. The first prism structures 111 are arranged at intervals in the normal direction (e.g., direction D1) of the second light incident surface IS2 and extend in a direction (e.g., direction D2) parallel to the second light incident surface IS2. That is, in this embodiment, the configuration of each first prism structure 111 may be a stripe, but the disclosure is not limited thereto. In other embodiments, each first prism structure may also be in a columnar shape. Further, the plurality of first prism structures may be arranged in arrays in the direction D1 and the direction D2 on the substrate surface 115s1, so that the light distribution in multiple directions can be controlled.

More specifically, in the normal direction of the second light incident surface IS2, a spacing width Ws is provided between any two adjacent first prism structures 111 of this embodiment, and each first prism structure 111 has a first structure width W1. It is particularly noted that a ratio of the spacing width Ws to the first structure width W1 is less than 2. In an embodiment, the ratio of the spacing width Ws to the first structure width W1 is less than 2 and greater than or equal to 0.1. First of all, such a design enables the light-emitting distribution of the backlight module 100 in the anti-peeping axial direction to be more uniform and smooth when the display device 10 operates in the sharing mode, which helps to improve the visual quality of the display device 10 at various viewing angles. It is particularly noted that if the ratio of the spacing width Ws to the first structure width W1 is greater than 2, a light-collecting property of the first prism sheet 110 may be reduced, and the anti-peeping effect of the anti-peeping mode is thus affected.

FIG. 4 shows a first prism sheet 110CE of a comparative example, where a plurality of first prism structures 111C thereof are closely arranged in a direction DI (i.e., a normal direction of the second light incident surface IS2) (i.e., adjacent first prism structures 111C are connected to each other). Therefore, the light L1 (the light transmitted to the first prism structures 111C) from the second light guide plate LGP2 is deflected by the first prism structures 111C and guided to a specific area after passing through the first prism sheet 110CE. That is, in the sharing mode, the light L1 has a discontinuous light-emitting angle range after passing through the first prism sheet 110CE.

Specifically, when the backlight module using the first prism sheet 110CE of the aforementioned comparative example operates in the anti-peeping mode (for example, when the first light source LS1 of FIG. 2 is disabled and the second light source LS2 is enabled), the configuration of the first prism sheet 110CE can enhance the light-collecting property after the light passes through, and an anti-peeping effect is thereby achieved. It is particularly noted that the light-collecting property of the first prism sheet 110CE acts in a direction (e.g., direction D1) perpendicular to an extending direction of the first prism structures 111C. Therefore, the anti-peeping axial direction is perpendicular to the extending direction of the first prism structures 111C, that is, the anti-peeping axial direction is parallel to the direction D1. As shown in FIG. 5A, the backlight module operating in the anti-peeping mode has the light-collecting property in the directions of azimuth angles of 0° and 180° (i.e., direction D1), but does not have the light-collecting property in the directions of azimuth angles of 90° and 270°.

However, when the backlight module using the first prism sheet 110CE of the aforementioned comparative example operates in the sharing mode (for example, when both the first light source LS1 and the second light source LS2 of FIG. 2 are enabled), the close arrangement design of the plurality of first prism structures 111C on the first prism sheet 110CE causes discontinuity in the light-emitting distribution (i.e., having an obvious dark area DKA) of the backlight module in the directions of azimuth angle 0° and azimuth angle 180° (i.e., direction D1), as shown in FIG. 5B.

To solve this problem, in this embodiment, the first prism structures 111 on the first prism sheet 110 are arranged at intervals (as shown in FIG. 2 and FIG. 3A), and the ratio of the spacing width Ws to the first structure width W1 is less than 2. Since a partial surface of the substrate surface 115s1 between the first prism structures 111 is exposed, the partial surface does not generate obvious deflection for other light L2 (light not transmitted to the first prism structures 111) from the second light guide plate LGP2. Therefore, the light L2 does not be limited to a specific light-emitting angle range after passing through the first prism sheet 110, for example, it can be directed to a light-emitting angle corresponding to the dark area DKA in FIG. 5B.

Therefore, when the backlight module 100 of this embodiment operates in the sharing mode, its light-emitting distribution (as shown in FIG. 6B) is more smooth (continuous) in the directions of azimuth angles of 0° and 180° than the light-emitting distribution of the backlight module of the aforementioned comparative example (as shown in FIG. 5B), and there is no obvious dark area DKA, which helps to improve the visual quality of the display device 10 at various viewing angles. When the backlight module 100 of this embodiment operates in the anti-peeping mode, its light-emitting distribution (as shown in FIG. 6A) is similar to the light-emitting distribution of the backlight module of the aforementioned comparative example (as shown in FIG. 5A).

Further, in this embodiment, a cross-sectional profile of each first prism structure 111 in a cross-sectional plane perpendicular to the substrate surface 115s1 and the second light incident surface IS2 may be a triangle. For instance, each of the first prism structures 111 may have a vertex angle β away from the first substrate 115, and the vertex angle β is preferably 60 degrees. Nevertheless, the disclosure is not construed as limited thereto. In other embodiments, the cross-sectional profile of each first prism structure may also be a trapezoid or a polygon.

It is particularly noted that, in another embodiment, in order to improve a concealing property, the first prism sheet 110A may be further provided with a diffusion layer 118 (as shown in FIG. 3B) on another substrate surface 115s2 facing away from the first prism structures 111. Nevertheless, the disclosure is not construed as limited thereto. In order to improve the visual quality, the diffusion layer 118 in FIG. 3B may also be replaced by an anti-glare layer, a microstructure layer, or other functional film layers.

It is particularly noted that in order to improve the uniformity of light emission of the backlight module 100 in the sharing mode, in the backlight module 100, one or more optical films may be selectively disposed between the first light guide plate LGP1 and the second light guide plate LGP2. For instance, in this embodiment, a second prism sheet 120 and a diffusion sheet 150 may be selectively disposed between the first light guide plate LGP1 and the second light guide plate LGP2, as shown in FIG. 2. Nevertheless, the disclosure is not construed as limited thereto. In other embodiments, the optical film may be a diffusion film, two inverse prism films, a combination of the above optical films, or other suitable optical films. Specifically, the second prism sheet 120 may include a second substrate 125 and a plurality of prism structures 121 disposed on the second substrate 125. The prism structures 121 extend in the normal direction (e.g., direction D2) of the first light incident surface IS1 and are, for example, arranged in a direction (e.g., direction D1) parallel to the first light incident surface IS1 of the first light guide plate LGP1 on a side of the second substrate 125 facing the second light guide plate LGP2, but the disclosure is not limited thereto. In this embodiment, the diffusion sheet 150 may be disposed between the second prism sheet 120 and the first light guide plate LGP1, but the disclosure is not limited thereto. In other embodiments, the diffusion sheet 150 may be disposed between the second prism sheet 120 and the second light guide plate LGP2.

In order to further improve the visual quality in the sharing mode, in another embodiment, in the display device, another diffusion sheet (not shown) may be disposed on the side of the first prism sheet 110 facing away from the second light guide plate LGP2. Further, the another diffusion sheet may be an anisotropic diffusion sheet, a scattering property thereof acts only in a direction perpendicular to the anti-peeping axial direction.

It is particularly noted that in this embodiment, the display device 10 is provided with the backlight module 100, and by selectively enabling or disabling the first light source LS1, the effect of switching to the sharing mode or the anti-peeping mode can be achieved. In order to further enhance the anti-peeping effect, the display device 10 may selectively include an electronically-controlled viewing angle switching device 300 disposed between the backlight module 100 and the display panel 200. For instance, the electronically-controlled viewing angle switching device 300 may be an electrically-controlled liquid crystal panel, which is used to reduce light emission within a specific viewing angle range (for example, when a light beam passes through the electronically-controlled viewing angle switching device 300, a local minimum value of a horizontal light-emitting viewing angle distribution curve falls at 45 degrees and 135 degrees), but the disclosure is not limited thereto.

Some other embodiments are listed below to illustrate the disclosure in detail. Identical reference numerals are used to represent identical components, and descriptions of identical technical contents are omitted. For the omitted parts, description thereof may be found with reference to the foregoing embodiments, which is described in detail below.

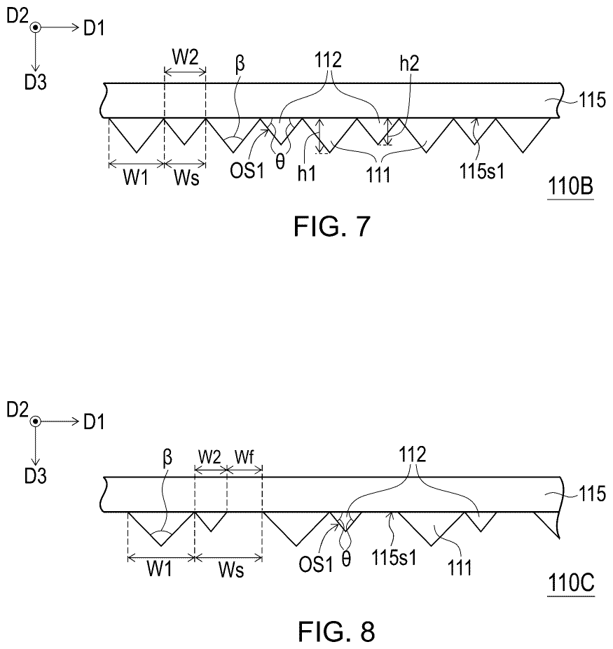

FIG. 7 is a schematic cross-sectional view of a first prism sheet according to a second embodiment of the disclosure. With reference to FIG. 7, a first prism sheet 110B of this embodiment is different from the first prism sheet 110 of FIG. 3A in that the first prism sheet 110B of this embodiment further includes a plurality of second prism structures 112. The second prism structures 112 and the first prism structures 111 are arranged at an alternating manner in the normal direction (e.g., direction D1) of the second light incident surface IS2.

It is particularly noted that in the normal direction (e.g., direction D3) of the substrate surface 115s1, each first prism structure 111 and each second prism structure 112 have a first height h1 and a second height h2, respectively. Further, the second height h2 of each second prism structure 112 is less than the first height h1 of each first prism structure 111. For example, a ratio of the second height h2 to the first height h1 is less than or equal to 0.9 and greater than or equal to 0.1. On the other hand, in the normal direction (e.g., direction D1) of the second light incident surface IS2, each second prism structure 112 has a second structure width W2. Further, the second structure width W2 may be less than or equal to the first structure width W1 of each first prism structure 111.

In this embodiment, the spacing width Ws between any two adjacent first prism structures 111 may be less than the first structure width W1, and the second structure width W2 may be equal to the spacing width Ws. From another perspective, each second prism structure 112 has an optical surface OS1 facing the second light guide plate LGP2 of FIG. 2. Further, an included angle θ between the optical surface OS1 and the substrate surface 115s1 is greater than or equal to 10 degrees and less than or equal to 45 degrees (for example, the vertex angle of each second prism structure 112 is greater than or equal to 90 degrees and less than or equal to 160 degrees). Accordingly, without affecting the anti-peeping performance, the backlight module using the first prism sheet 110B of this embodiment and operating in the sharing mode can have a more uniform and continuous light-emitting distribution in the anti-peeping axial direction.

FIG. 8 is a schematic cross-sectional view of a first prism sheet according to a third embodiment of the disclosure. With reference to FIG. 8, a first prism sheet 110C of this embodiment is different from the first prism sheet 110B of FIG. 7 in that the arrangement of the plurality of prism structures on the prism sheet is different. Specifically, in this embodiment, the arrangement of the second prism structures 112 does not entirely occupy a spacing area between any two adjacent first prism structures 111. In other words, in the first prism sheet 110C of this embodiment, a portion of the substrate surface 115s1 of the first substrate 115 is exposed.

More specifically, in the normal direction (e.g., direction D1) of the second light incident surface IS2, a partial surface of the substrate surface 115s1 between any two adjacent first prism structures 111 and not covered by the second prism structures 112 has a plane width Wf. It is particularly noted that a ratio of the plane width Wf to the spacing width Ws may be greater than or equal to 0.5. From another perspective, the spacing width Ws between any two adjacent first prism structures 111 may be less than the first structure width W1, and a ratio of the second structure width W2 to the spacing width Ws may be less than or equal to 0.5.

In the first prism sheet 110C of this embodiment, the partial surface of the substrate surface 115s1 that is not provided with the prism structures can further improve the uniformity of the light-emitting distribution in the anti-peeping axial direction of the backlight module operating in the sharing mode, and can also suppress the generation of stray light at a specific anti-peeping viewing angle when the backlight module operates in the anti-peeping mode.

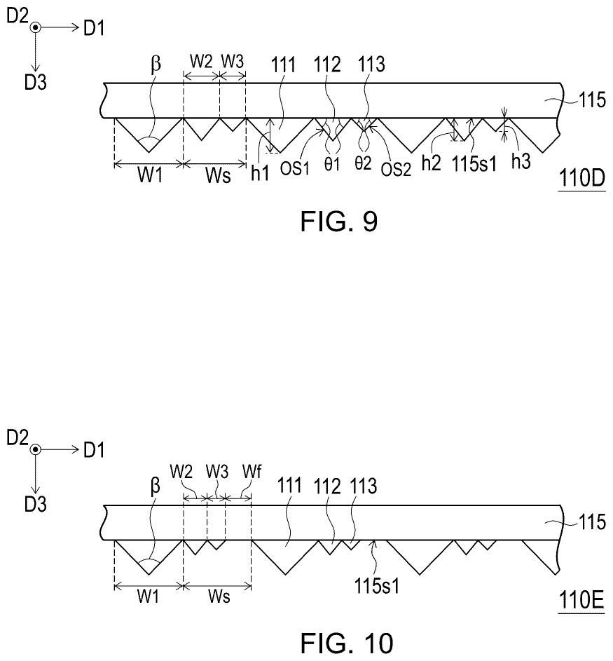

FIG. 9 is a schematic cross-sectional view of a first prism sheet according to a fourth embodiment of the disclosure. With reference to FIG. 9, a first prism sheet 110D of this embodiment is different from the first prism sheet 110B of FIG. 7 in that the first prism sheet 110D of this embodiment further includes a plurality of third prism structures 113. The first prism structures 111, the second prism structures 112, and the third prism structures 113 are alternately arranged in the normal direction (e.g., direction D1) of the second light incident surface IS2.

In the normal direction (e.g., direction D3) of the substrate surface 115s1, each first prism structure 111, each second prism structure 112, and each third prism structure 113 have the first height h1, the second height h2, and a third height h3, respectively. It is particularly noted that the second height h2 of each second prism structure 112 is less than the first height h1 of each first prism structure 111, and the third height h3 of each third prism structure 113 is less than the second height h2 of each second prism structure 112.

On the other hand, in the normal direction (e.g., direction D1) of the second light incident surface IS2, each first prism structure 111, each second prism structure 112, and each third prism structure 113 have the first structure width W1, the second structure width W2, and a third structure width W3, respectively. It is particularly noted that a sum of the second structure width

W2 and the third structure width W3 is less than or equal to the first structure width W1 of each first prism structure 111. In this embodiment, the sum of the second structure width W2 and the third structure width W3 may be substantially equal to the spacing width Ws between any two adjacent first prism structures 111.

From another perspective, each second prism structure 112 and each third prism structure 113 respectively have the optical surface OS1 and an optical surface OS2 facing the second light guide plate LGP2 of FIG. 2. It is particularly noted that an included angle θ2 between the optical surface OS2 and the substrate surface 115s1 may be less than or equal to an included angle θ1 between the optical surface OS1 and the substrate surface 115s1. Preferably, the included angle θ1 and the included angle θ2 may each be greater than or equal to 10 degrees and less than or equal to 45 degrees (for example, the vertex angle is greater than or equal to 90 degrees and less than or equal to 160 degrees). Accordingly, without affecting the anti-peeping performance, the backlight module using the first prism sheet 110D of this embodiment and operating in the sharing mode can have a more uniform and continuous light-emitting distribution in the anti-peeping axial direction.

FIG. 10 is a schematic cross-sectional view of a first prism sheet according to a fifth embodiment of the disclosure. With reference to FIG. 10, a first prism sheet 110E of this embodiment is different from the first prism sheet 110D of FIG. 9 in that the arrangement of the plurality of prism structures on the prism sheet is different. Specifically, in this embodiment, the arrangement of the second prism structures 112 and the third prism structures 113 does not entirely occupy the spacing area between any two adjacent first prism structures 111. In other words, in the first prism sheet 110E of this embodiment, a portion of the substrate surface 115s1 of the first substrate 115 is exposed.

More specifically, in the normal direction (e.g., direction D1) of the second light incident surface IS2, a partial surface of the substrate surface 115s1 between any two adjacent first prism structures 111 and not covered by the second prism structures 112 and the third prism structures 113 has the plane width Wf. It is particularly noted that in this embodiment, a sum of the second structure width W2, the third structure width W3 and the plane width Wf is less than or equal to the first structure width W1, and the plane width Wf is greater than or equal to the second structure width W2 and the third structure width W3.

In the first prism sheet 110E of this embodiment, the partial surface of the substrate surface 115s1 that is not provided with the prism structures can further improve the uniformity of the light-emitting distribution in the anti-peeping axial direction of the backlight module operating in the sharing mode, and can also suppress the generation of stray light at a specific anti-peeping viewing angle when the backlight module operates in the anti-peeping mode.

In view of the foregoing, in backlight module and the display device provided by the first embodiment of the disclosure, the second light guide plate is disposed on one side of the first light-emitting surface of the first light guide plate. The second light-emitting surface of the second light guide plate is arranged opposite to the first light guide plate and is provided with the first prism sheet. The first substrate of the first prism sheet is provided with the plurality of first prism structures on the substrate surface facing the second light guide plate. The first prism structures are arranged at intervals according to the spacing width in the normal direction of the second light incident surface of the second light guide plate. Through the arrangement of the first prism structures, the light-collecting property of the display device in the anti-peeping axial direction may be effectively improved when the display device operates in the anti-peeping mode. By setting the ratio of the aforementioned spacing width to the structure width of each first prism structure in the normal direction of the second light incident surface to be less than 2, the light-emitting distribution of the backlight module in the anti-peeping axial direction can be more uniform and continuous when the display device operates in the sharing mode, and this helps to improve the visual quality of the display device at various viewing angles.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A backlight module, comprising a first light guide plate, a first light source, a second light guide plate, a second light source, and a first prism sheet, wherein
the first light guide plate has a first light incident surface and a first light-emitting surface connected to each other,
the first light source is disposed on a side of the first light incident surface of the first light guide plate,
the second light guide plate is disposed on a side of the first light-emitting surface of the first light guide plate and overlaps the first light-emitting surface, and the second light guide plate has a second light incident surface and a second light-emitting surface connected to each other, wherein the first light incident surface is not parallel to the second light incident surface,
the second light source is disposed on a side of the second light incident surface of the second light guide plate, and
the first prism sheet is disposed on a side of the second light-emitting surface of the second light guide plate, and the first prism sheet comprises a first substrate and a plurality of first prism structures, wherein
the first substrate has a substrate surface facing the second light-emitting surface, and
the first prism structures are disposed on the substrate surface, and the first prism structures are arranged at intervals in a normal direction of the second light incident surface, wherein in the normal direction of the second light incident surface, each of the first prism structures has a first structure width, a spacing width is provided between any two adjacent first prism structures, and a ratio of the spacing width to the first structure width is less than 2.

2. The backlight module according to claim 1, wherein each of the first prism structures has a vertex angle away from the first substrate, and an angle of the vertex angle is 60 degrees.

3. The backlight module according to claim 1, wherein the first prism sheet further comprises a plurality of second prism structures, the first prism structures and the second prism structures are alternately arranged in the normal direction of the second light incident surface, in a normal direction of the substrate surface, each of the first prism structures has a first height and each of the second prism structures has a second height, and in the normal direction of the second light incident surface, each of the second prism structures has a second structure width, wherein the second height is less than the first height, and the second structure width is less than or equal to the first structure width.

4. The backlight module according to claim 3, wherein the spacing width is less than or equal to the first structure width, and the second structure width is less than the spacing width.

5. The backlight module according to claim 4, wherein a ratio of the second structure width to the spacing width is less than or equal to 0.5.

6. The backlight module according to claim 3, wherein each of the first prism structures has a vertex angle away from the first substrate, an angle of the vertex angle is 60 degrees, each of the second prism structures has an optical surface facing the second light guide plate, and an included angle between the optical surface and the substrate surface is greater than or equal to 10 degrees and less than or equal to 45 degrees.

7. The backlight module according to claim 3, wherein the first prism sheet further comprises a plurality of third prism structures, and the third prism structures and the first prism structures are alternately arranged in the normal direction of the second light incident surface, in the normal direction of the substrate surface, each of the third prism structures has a third height, and the third height is less than the second height.

8. The backlight module according to claim 7, wherein the spacing width is less than or equal to the first structure width.

9. The backlight module according to claim 7, wherein each of the first prism structures has a vertex angle away from the first substrate, an angle of the vertex angle is 60 degrees, each of the second prism structures has a first optical surface facing the second light guide plate, a first included angle is provided between the first optical surface and the substrate surface, each of the third prism structures has a second optical surface facing the second light guide plate, a second included angle is provided between the second optical surface and the substrate surface, each of the first included angle and the second included angle is greater than or equal to 10 degrees and less than or equal to 45 degrees, and the second included angle is less than or equal to the first included angle.

10. The backlight module according to claim 1, wherein the backlight module further comprises a diffusion sheet and a second prism sheet, wherein
the diffusion sheet is disposed between the first light guide plate and the second light guide plate, and
the second prism sheet is disposed between the first light guide plate and the second light guide plate and comprises a second substrate and a plurality of prism structures, wherein
the prism structures are disposed on a side of the second substrate facing the second light guide plate.

11. The backlight module according to claim 1, wherein a diffusion layer is provided on a side of the first substrate facing away from the first prism structures.

12. A display device comprising a backlight module and a display panel, wherein
the backlight module comprises a first light guide plate, a first light source, a second light guide plate, a second light source, and a first prism sheet, wherein
the first light guide plate has a first light incident surface and a first light-emitting surface connected to each other,
the first light source is disposed on a side of the first light incident surface of the first light guide plate,
the second light guide plate is disposed on a side of the first light-emitting surface of the first light guide plate and overlaps the first light-emitting surface, and the second light guide plate has a second light incident surface and a second light-emitting surface connected to each other, wherein the first light incident surface is not parallel to the second light incident surface,
the second light source is disposed on a side of the second light incident surface of the second light guide plate, and
the first prism sheet is disposed on a side of the second light-emitting surface of the second light guide plate, and the first prism sheet comprises a first substrate and a plurality of first prism structures, wherein
the first substrate has a substrate surface facing the second light-emitting surface, and
the first prism structures are disposed on the substrate surface, and the first prism structures are arranged at intervals in a normal direction of the second light incident surface, wherein in the normal direction of the second light incident surface, each of the first prism structures has a first structure width, a spacing width is provided between any two adjacent first prism structures, and a ratio of the spacing width to the first structure width is less than 2, and
the display panel is disposed on a side of the second light-emitting surface of the second light guide plate and overlaps the second light-emitting surface.

13. The display device according to claim 12, wherein the display device further comprises an electronically-controlled viewing angle switching device, and the first prism sheet is disposed between the second light guide plate and the electronically-controlled viewing angle switching device.
